(19) United States
(12) Patent Application Publication
(10) Pub. No.: US 2007/0160006 A1
(43) Pub. Date: Jul. 12, 2007

(54) Method and apparatus for improving wireless communication between motor vehicles

(75) Inventors: Marco Roggero, Aachen (DE); Andries Van Wageningen, Wijlre (NL); Hans-Juergen Reumerman, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics, N.V., Eindhoven (NL)

(21) Appl. No.: 10/588,129

(22) PCT Filed: Jan. 17, 2005
(86) PCT No.: PCT/IB05/50177

§ 371 Date: Jul. 31, 2006

(30) Foreign Application Priority Data
Jan. 29, 2004 (EP) 04100315.3

(51) Int. Cl. H04Q 7/00; H04J 3/24

(52) U.S. Cl. 370/331; 370/349

(57) ABSTRACT

In order to provide a method of improving wireless communication between motor vehicles, wherein the motor vehicles transmit messages to a stationary unit (100), by means of which the exchange of messages is possible even between motor vehicles which are far away from one another, in the stationary unit (100) the received messages are processed and new messages are generated. A corresponding stationary unit (100) is also provided.

The invention relates to a method of improving wireless communication between motor vehicles, wherein the motor vehicles transmit messages to a stationary unit, and also to a corresponding stationary unit.

Wireless communication between motor vehicles allows the exchange of safety-related information and messages to control the flow of traffic, in order for example to reduce the number of traffic accidents. For this, use is made inter alia of ad-hoc networks of mobile nodes which organize themselves for the purpose of transmitting information between the nodes without a stationary control device. For this, the motor vehicles are equipped with appropriate transmitters/receivers and other devices known to the person skilled in the art for evaluating and creating and possibly storing desired messages. Using such networks, it is possible for example for an emergency vehicle, when approaching a crossroads, to make the other motor vehicles aware of its presence by exchanging corresponding information and for the crossroads to be kept free in order for the emergency vehicle to pass quickly through. The motor vehicles may likewise exchange information about their respective speeds, in order to avoid a collision when changing lanes or filtering into a lane, and also to avert traffic jams forming if the traffic density is high.

In this case, it has proven to be disadvantageous that, in the case of a low traffic density, that is to say a large distance between the motor vehicles, and a maximum range of the radio signals for exchanging messages, the establishment of a suitable network of a number of motor vehicles is practically not possible.

In order to solve this problem, document U.S. 2002/0198632 A1 proposes that a receiving station integrated in the road infrastructure be used to exchange the messages between motor vehicles that are far apart, wherein further nodes of the network may be provided in the infrastructure. Nothing is disclosed here about special functions and modes of action of the receiving station.

The most widely known communication system for communicating between motor vehicles is the DSRC (Dedicated Short Range Communication) system developed in 1996, with two different standards for operation having been developed in the USA and in Europe. In the USA, an IEEE 802.11a protocol is used, which operates in the 5 GHz band and places special requirements on access to the communication medium or for the technical configuration of data transmission. In Europe, on the other hand, a 5.8 GHz band is used, with the development of the access protocol and test operation not yet having been completed.

In addition, in France, a further system (“Cofiroute”) for exchanging warning messages is known, wherein for this a two-way communication takes place between a motor vehicle and a stationary unit. The stationary units are arranged along a road at distances of about 2 kilometers apart. An operator can thus forward the warning messages received by the stationary units to all the other road users.

The publication by Chisalita, loan and Shahmehri, Nahid: “Active Support for Traffic Safety Applications through Vehicular Communication”, Linkö ping University, Sweden, describes a stationary unit for exchanging messages between two motor vehicles when the distance between them is too great. No further processing of the messages takes place in the stationary unit.

The publication by Leighton, James and Jones, Simon: “Implementation of a Virtual Beacon Network for Traffic Information Utilising GPS/GSM and DSRC” describes a system in which data processing takes place in a central control unit, wherein the messages received by the stationary units are transmitted to the central control device by a number of stationary units. This requires additional lines or connections between the stationary units and the central control unit.

U.S. Pat. No. 5,987,374 describes a stationary unit at the edge of the road by means of which only the vehicle speed and the time it travels past the stationary unit are stored, in order to predict a traffic jam. The corresponding data are transmitted to a central control device and further processed there.

The publication by Tian, Jing and Rothermel, Kurt: “Building Large Peer-to-Peer Systems in Highly Mobile ad-hoc Networks: New Challenges?”, University of Stuttgart, describes a system in which, e.g. on a road with a number of lanes, in the direction of travel of the number of motor vehicles, messages are passed on in each case from motor vehicle to motor vehicle for example toward a crossroads, so that the motor vehicles nearest the crossroads obtain the most information. This causes problems in particular in these motor vehicles with regard to the amount of data that has to be processed.

In the known methods and systems for communication between motor vehicles, it is to be regarded as disadvantageous that in the case of pure ad-hoc networks without a stationary unit a large amount of information always has to be exchanged between the nodes or motor vehicles, so that self-organization is not possible, particularly when there are large distances between them. To this there are added difficulties in self-organization in particular in the case of partially disrupted radio links. For this purpose, although it is known to use stationary units for example at the edge of the road, it is not possible with these to process information in order to improve the communication between the motor vehicles, since the evaluation of the information always takes place in a central control unit that has to be connected in a complex manner. The known systems often offer only insufficient reliability, in particular when exchanging safety-related information.

It is an object of the invention to provide a method of improving communication between motor vehicles, by means of which the quality of the information that is to be exchanged and the reliability of the system are improved. Furthermore, a corresponding stationary unit is to be provided in order to facilitate communication between the motor vehicles. These objects are achieved by the features specified in claim 1 and in claim 6.

The core concept of the invention consists in that a stationary unit is provided which can be integrated into an infrastructure of a road, in order to avoid the communication problems that occur between motor vehicles in particular in the event of low traffic densities. In the stationary unit, the messages received from motor vehicles are processed and passed on to other motor vehicles. Prior transmission to an additional central control device does not take place. For this purpose, the incoming messages are stored in the stationary unit and new messages are generated in the stationary unit, which new messages are composed of information from earlier incoming and stored messages. For this purpose, the stationary unit is provided with a control device in order automatically to generate corresponding messages for distribution to other motor vehicles, as a function of the traffic situation, the time of day, the weather and road conditions and possibly also while taking into account signals from safety or emergency vehicles. The control device is implemented by hardware and/or software in the stationary unit.

Such messages are to be understood as meaning messages relating to a hazard that has surprisingly appeared or to an accident on the road, the state of the road or traffic density, notices regarding the transporting of hazardous materials or identification signals of a motor vehicle. While the motor vehicle is traveling along a road, information about the traffic density, the state of the road, the weather conditions and possibly further information such as availability of gas stations or other services is detected by suitable sensors in the motor vehicle and transmitted to the stationary unit via radio. The radio protocols used for this may be configured by the person skilled in the art in any desired manner. By way of example, the IEEE 802.11a standard may be used.

It is obvious that the stationary unit is fitted in a stationary manner for example on a road sign or a traffic light gantry over a road. However, it is also possible for the stationary unit to be installed for example in a police vehicle, in order during use to detect the corresponding information about the other road users in the region of the police vehicle and transmit corresponding messages to them. It is obvious to the person skilled in the art that the corresponding transmitters/receivers for communicating with the motor vehicles are present in the stationary unit, with in particular a battery supply being preferred in a stationary unit for independent operation of the stationary unit.

In order to generate new messages from the messages received by the stationary unit, the corresponding devices are provided in the stationary unit. These are, inter alia, a clock for temporal coordination, a device for storing, processing and generating messages, wherein the stationary unit is preferably designed such that it can be programmed in the desired manner. This means that in each case desired messages are generated from the incoming messages as a function of the parameters defined by the operator. By way of example, a corresponding message can be transmitted by an emergency vehicle to the stationary unit, which then transmits a warning signal to all the motor vehicles in the receiving range of the stationary unit, in order to allow the emergency vehicle to pass freely through. Furthermore, there may also be in the stationary unit dedicated sensors for example for light or weather conditions. A corresponding processing or message generation unit can be implemented by the person skilled in the art in any desired manner. By way of example, it is possible that in the message generation unit a message is generated from the positions and speeds of the motor vehicles, which message contains information about an optimum traveling speed of a motor vehicle newly traveling into the detection range of the stationary unit.

The advantage of the invention is that the traffic and weather conditions in the region in which the motor vehicle is traveling are ascertained by sensors of the motor vehicle and transmitted to the stationary unit. As soon as another motor vehicle travels through this region, the messages stored in said stationary unit are transmitted to this vehicle so as to ensure a safe journey. Likewise, hazards or an accident may be reported by motor vehicles to the stationary unit. Furthermore, an emergency vehicle or a vehicle transporting hazardous materials can make the other road users aware of its presence by transmitting corresponding messages to the stationary unit. It is also possible for the identification features transmitted by a motor vehicle to the stationary unit, for example the respective registration numbers, to be used by the police to monitor the traffic. In particular, it is possible for any information to be buffer-stored in the stationary unit until another motor vehicle communicates with the stationary unit. This occurs in the event of a low traffic density, when a direct network connection between a number of road users or nodes is not possible. The stationary units also ensure an increased reliability, since on the one hand an undisrupted radio link to the motor vehicles is provided at all times and on the other hand the amount of data that is to be transmitted is limited by the processing of the messages in the stationary unit.

Advantageous configurations of the invention are characterized in the dependent claims.

The configuration indicated in claim 2 and claim 7 achieves that the amount of data to be processed in the stationary unit is limited. In a filter device appropriately configured by the person skilled in the art, the messages coming into the stationary unit are searched for duplicates or incorrect messages. By way of example, a hazard may be reported to the stationary unit by a number of motor vehicles, wherein in each case the location of the hazard is contained as information. If these locations lie within certain tolerances, the filter unit will decide that these are all the same hazard and will store the corresponding information only once. Likewise, incorrect and incomplete information can be separated out or earlier incoming messages from the same motor vehicle can be deleted.

Preferably, in accordance with claim 3 and claim 8, the incoming messages are stored in the stationary unit in order where appropriate to be able to make use of them later or to monitor the traffic situation over a longer period. In order to limit the amount of data to be stored, it is proposed that the messages are in each case provided with a time signal in order to delete obsolete messages after a corresponding time has elapsed. Likewise, the messages may be divided into various information sectors, for example weather information or messages about a hazard, and stored in corresponding memories. It is furthermore possible for the messages to be provided with a priority in each case, for example a warning message is assigned a higher priority than a general weather information item. Accordingly, a message of higher priority can be fed for processing first. In addition, the position of the motor vehicle from which the message was received and/or a reliability of the message can be stored, that is to say whether it was received in full or in fragments.

In order for example for the driver of the motor vehicle to retrieve desired information, in accordance with claim 4 and claim 9 it is proposed that upon a request by the motor vehicle or user, a specific message is generated in the stationary unit. For this purpose, a corresponding query relating, for example, to the current traffic density in the region of the stationary unit can be sent to the latter, whereupon the corresponding information is determined by a message generation device from the stored messages and transmitted to the requesting motor vehicle.

In order to operate the stationary unit in an energy-saving manner, in accordance with claim 5 and claim 10 it is proposed that the stationary unit is activated only when a motor vehicle approaches. This may be effected by a proximity sensor integrated in the stationary unit, which registers the proximity of a motor vehicle for example by means of electromagnetic waves and activates the corresponding transmitters/receivers of the stationary unit. It is likewise possible for an identification signal to be emitted by a traveling motor vehicle and received by a passive receiver in the stationary unit. As soon as the motor vehicle has approached up to a definable distance, communication is established between the motor vehicle and the stationary unit.

It is obvious to the person skilled in the art that the method and the stationary unit have been described using the example of road traffic. However, the method and the apparatus are also suitable for controlling and monitoring all other types of goods flow.

The invention will be further described with reference to an example of embodiment shown in the drawing to which, however, the invention is not restricted.

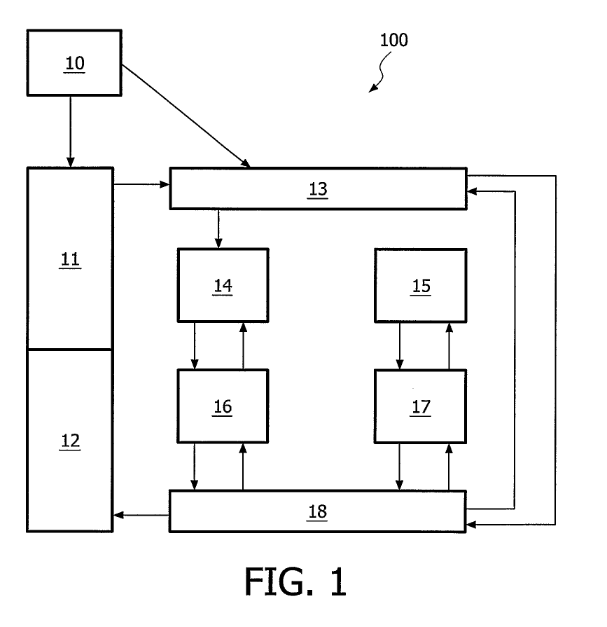

FIG. 1 shows a schematic diagram of the stationary unit.

FIG. 1 shows a stationary unit 100 with its essential parts. The arrows indicate the direction of a flow of information between the various components of the stationary unit 100. The approaching of a motor vehicle to the stationary unit 100 is detected by means of a proximity sensor 10. The proximity sensor 10 activates the receiver 11, the transmitter 12 and the device 13 for processing and filtering messages which are received from the motor vehicle. Where appropriate, a corresponding request from the motor vehicle may be received directly by the receiver 11, by means of which request a specific information item or message is to be called up.

The incoming inquiries and messages from the motor vehicle are transmitted to the device 13, from which they are forwarded either directly to a message generation unit 18 for generating and transmitting a desired message via the transmitter 12. If there is only one incoming message, this is forwarded to a control device 14 of the information database 16. The device 13 filters out duplicated or incomplete messages and transmits only relevant information to the information database 16 or messages to the message database 17. Likewise, all messages transmitted by a motor vehicle may be detected by the device 13, in order to delete in each case the older messages from this motor vehicle. This occurs when a motor vehicle is in the detection range of the stationary unit 100 for a relatively long time. For this purpose, the messages may be encoded in a vehicle-specific manner.

The data stored in the information database 16 are provided, inter alia, with parameters regarding the topicality of the information, the type of information, their priority and reliability. This information is checked regularly by the control unit 14 and deleted or changed for example after a certain time has elapsed, in order always to have a current stock of data in the information database 16. Likewise, information can be combined by the control unit 14 if for example two identical information items relating to a hazard on the road are stored. The control unit 14 interprets the incoming messages, processes them and stores them in the information database 16 in order to generate new messages.

In the same manner, the messages filtered by the processing and filter device 13 are stored in a message database 17 which is controlled by a control unit 15. The messages stored here are provided with parameters such as, inter alia, the vehicle position, a vehicle identification, a time signal, a classification according to the type of message, its priority and reliability, wherein the messages stored in the message database 17 are checked regularly by the control unit 15 with regard to their topicality and where necessary deleted or changed. The stored messages 17 may also be combined or a new message can be generated there from, as described above. The main use of the message database 17 or the control unit 15 consists in a relay function, which means that the messages stored in the message database 17 are forwarded from one motor vehicle to the other when the distance between them is too great for direct communication. For this purpose, specific messages may be requested for example by the request from another motor vehicle.

All the information which is transmitted to the stationary unit 100 is stored in the information database 16 and periodically checked by the control unit 14 and brought up to date. All the messages which are received by the stationary unit 100 are stored in the message database 17. These messages are periodically checked by the control unit 15 and brought up to date.

As soon as a motor vehicle approaches the receiving range of the stationary unit 100, this is ascertained by the proximity sensor 10 and then the messages currently required for a safe journey are generated by the message generation unit 18 and transmitted via the transmitter 12 to the motor vehicle. For this, the message generation unit 18 uses data from the information database 16 or message database 17. It is also possible for a corresponding message or information item to be transmitted to the motor vehicle as a result of a request.

By way of example, from all the messages stored in the message database 17 relating to the positions and speeds, the message generation unit 18 can make a prognosis about the current traffic density in the region of the stationary unit 100, taking account of the times that have in each case elapsed since the messages were received, and transmit it to a motor vehicle, wherein an optimal traveling speed for avoiding jams is also supplied.

It is also possible for a service vehicle to approach the stationary unit 100 and request corresponding messages from the stationary unit 100, for example the status of the stationary unit, that is to say whether there is still enough battery capacity, and information about traffic conditions and about the operation of the stationary unit 100.

LIST OF REFERENCES:

10 proximity sensor
11 receiver
12 transmitter
13 processing and filter device
14 control unit
15 control unit
16 information database
17 message database
18 message generation unit
100 stationary unit

1. A method of improving wireless communication between motor vehicles, wherein the motor vehicles transmit messages to a stationary unit characterized in that in the stationary unit the received messages are processed and new messages are generated.

2. A method as claimed in claim 1, characterized in that the messages entering the stationary unit are filtered.

3. A method as claimed in claim 1, characterized in that the incoming messages are stored in the stationary unit, wherein they are checked in particular with regard to topicality and/or type of information and/or priority and/or reliability and/or position of the motor vehicle.

4. A method as claimed in claim 1, characterized in that upon a request by a motor vehicle a specific message is generated in the stationary unit.

5. A method as claimed in claim 1, characterized in that the stationary unit is activated when a motor vehicle approaches.

6. A stationary unit for improving wireless communication between motor vehicles, wherein the motor vehicles transmit messages to the stationary unit characterized in that a device for processing received messages and a message generation unit are provided in the stationary unit.

7. A stationary unit as claimed in claim 6, characterized in that there is a filter device for incoming messages.

8. A stationary unit as claimed in claim 5, characterized in that in the stationary unit there is a message database for storing incoming messages, wherein a control unit checks the stored messages with regard to topicality and/or type of information and/or priority and/or reliability and/or position of the motor vehicle.

9. A stationary unit as claimed in claim 6, characterized in that upon a request by a motor vehicle a specific message can be generated in the stationary unit by the message generation unit.

10. A stationary unit as claimed in claim 6, characterized in that there is a proximity sensor in the stationary unit.
